(19) United States
(12) Patent Application Publication
(10) Pub. No.: US 2010/0030772 A1
(43) Pub. Date: Feb. 4, 2010

(54) SYSTEM AND METHOD FOR CREATING AND USING PERSONALITY MODELS FOR USER INTERACTIONS IN A SOCIAL NETWORK

(76) Inventors: Ran Zilca, Briarcliff Manor, NY (US); Caitlin Eschmann, Carmel, NY (US); Garrett Snider Hunyadi, Danbury, CT (US)

Correspondence Address: TUTUNJIAN + BITETTO, P.C., 20 CROSSWAYS PARK NORTH, SUITE 210, WOODBURY, NY, 11797, US

(21) Appl. No.: 12/475,871

(22) Filed: Jun. 1, 2009

Related U.S. Application Data
(60) Provisional application No. 61/084,849, filed on Jul. 30, 2008.

(51) Int. Cl. G06F 3/01; G06F 17/30

(52) U.S. Cl. 707/5; 715/745; 700/94; 707/E17.014

(57) ABSTRACT

A social computing system and method includes a model creator configured to create an initial model of a user's musical preferences across a spectrum of attributes. The system and method further include a matching and comparison technique, which matches users based on the similarity of their respective musical preferences. The system and method further include an interactive display, allowing a user to view and interact with the nearby users who share the user's musical preferences.

### RELATED APPLICATION DATA

This application claims the benefit of U.S. Provisional Application Ser. No. 61/084,849, filed Jul. 30, 2008, which is incorporated by reference herein in its entirety.

### BACKGROUND

1. Technical Field

The present invention relates to human-computer interaction, and more particularly to social computing systems and methods that incorporate location awareness and employ music profiling models for interaction between users.

2. Description of the Related Art

Social Computing (SC) systems provide different ways for users to discover other users and then interact and communicate with the other users based on the discovered information. In many systems, each user has a profile that includes various different pieces of information about the user. The information in each user profile may include different user attributes which may be manually entered, automatically fed from an external system, or both.

One particular focus for manual entry in such profiles is frequently musical preference. This reflects the intuitive understanding that similarities in musical preference between people reflect underlying similarities in personality.

Indeed, current research bears out that intuition. There are acknowledged statistical correlations between areas of musical preference and personality attributes. To select one example, listeners of country music often espouse traditional family values. However, integrating this information into an SC system can prove difficult, due to the lack of an objective means for classifying musical preference. The genres usually used to describe music (e.g., “rock”, “rap”, “classical”) are poorly defined and extremely vague. Furthermore, a given song may have positive or negative connotations to an individual user separate and apart from the bare musical qualities. These facts make it difficult to fully integrate musical preference into Social Computing systems.

### SUMMARY

A method for determining a user's musical preferences is shown, including the steps of analyzing a plurality of audio specimens, such that the audio is scored according to a set of representative attributes, determining the user's degree of preference for the audio specimens, determining a musical preference model (MPM) for the user based on the user's degree of preference for the audio specimens and the representative attributes of those specimens, and storing the MPM in a storage module.

A method for social computing is also shown, including the steps of determining a matching user's current location, generating a list of users within a given radius of the user's location, retrieving from a storage module an MPM for each user on the list, comparing the MPMs of the users on the list to an MPM corresponding to the matching user, and displaying on a display device those users on the list whose MPMs are similar to the matching user's MPH.

A social computing system is shown, including a server, where the server includes an MPM generating module for generating an MPH based on a user's musical preferences, an MPM comparison module for generating a music match score based on a comparison of two MPMs, and a storage module for storing MPMs and user profiles.

### BRIEF DESCRIPTION OF DRAWINGS

The disclosure will provide details in the following description of preferred embodiments with reference to the following figures wherein:

FIG. 1 is an illustrative diagram showing a social computing system according to the present principles.

FIG. 2 is a block/flow diagram showing an exemplary method for generating a user's musical preference model (MPM).

FIG. 3 is a block/flow diagram showing an alternative method for generating a user's musical preference model (MPM).

FIG. 4 is a block/flow diagram showing an exemplary method for comparing two users' MPMs.

FIG. 5 is a block/flow diagram showing an exemplary method for social computing using users' locations and musical preference information.

FIG. 6 is an exemplary “overhead” visual representation of the locations of users having similar musical preferences.

FIG. 7 is an exemplary “perspective” visual representation of the locations of users having similar musical preferences.

FIG. 8 is an exemplary visual representation showing information and options for inter-user interaction.

FIG. 9 is an illustrative diagram showing a server for use in a social computing system according to the present principles.

### DETAILED DESCRIPTION OF PREFERRED EMBODIMENTS

Embodiments in accordance with present principles employ a model or models of music preference that is/are stored in a user profile. This permits users to find one another based on similarity in musical preference and have their personalities matched and grouped. This may also provide a local map representation of users by musical preference similarity.

In one illustrative embodiment, a system/method includes creating a musical preference model (MPM) and profile for a user and matching the MPMs of two users to obtain a music match score (MMS). The system/method also includes location awareness, allowing users to be filtered by geographic proximity or other filter.

Using a combination of the above elements, a variety of functions may be achieved by a social computing (SC) system. Users may be discovered by matching their MPMs with reference MPMs of other users (using the MMS). Users who know each other can check their music match using the MMS. User interaction may be adapted to the user's MPM. The information on users' MPMs, their MMSs with other users, and their locations, may be visualized so that the space of users may be browsed by music preference and proximity.

The above functions may be performed solely based on the musical preference data, or in combination with other types of information that exists in the profile. For example, a visualization showing the people who are closest in musical preference to a user may be filtered to show only women who are currently within half a mile of the user's present location and who share the same musical taste. In addition, functions that are not directly related to finding users and interacting with them may be obtained based on the elements of personality modeling, matching, and grouping to musical preference types. For example, users may receive content or content-recommendations based on their MPM.

In one embodiment, the content or content-recommendations are obtained by analyzing the statistical relationship between certain MPM groups and certain content, e.g., recommending content that is more likely to be consumed by users of similar preference.

It is to be understood that the present embodiments are described in terms of social computer systems; however, the present invention is much broader and may include any digital system, which is capable of employing musical preference and provides comparison using visual representations of such.

It should also be understood that the elements shown in the FIGS. may be implemented in various forms of hardware, software or combinations thereof. Preferably, these elements are implemented in a combination of hardware and software on one or more appropriately programmed devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), DVD and Blu-ray.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Other hardware, conventional and/or custom, may also be included. Their function may be carried out through the operation of program logic, through dedicated logic, through the interaction of program control and dedicated logic, or even manually, the particular technique being selectable by the implementer as more specifically understood from the context.

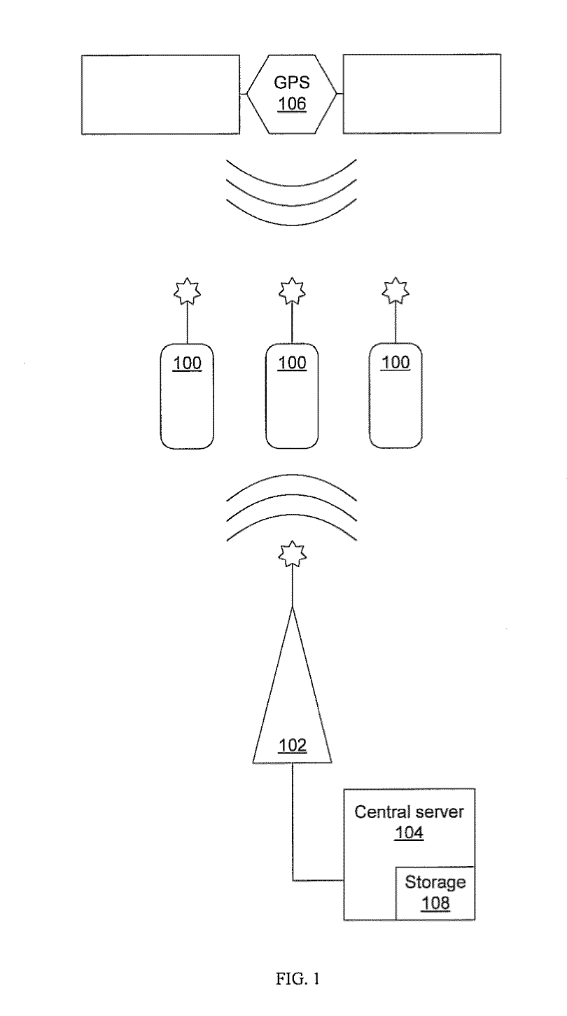

Referring now to the drawings in which like numerals represent the same or similar elements and initially to FIG. 1, a block/flow diagram shows system 10 in accordance with one illustrative embodiment. The system 10 includes one or more user devices 100, which are configured to communicate with a central server 104. As shown in FIG. 1, this communication may be wireless communication via a wireless communications station 102. The wireless communications station may represent a cell phone network, a wireless local area network (WLAN) hotspot, or any other system which allows the wireless transfer of data. Wireless communications station 102 is in communication with the central server 104 having storage 108, where the connection may be a direct connection, a local area network (LAN) connection, an internet connection, etc. Alternative means of communication between the user devices 100 and the central server may include wired connections (not shown), thereby obviating the need for a wireless communications station.

User devices 100 are preferably also configured to be location-aware. This may be implemented by configuring the user devices 100 to receive global positioning system (GUPS) signals from GUPS satellites 106. These signals allow the user devices 100 to determine their geographic locations. User devices 100 are preferably also configured to store and play music. In some embodiments, the user devices 100 may be cellular phones or personal digital assistants (PDAs), as shown in FIG. 1, or they may be location-aware desktop computers, or any other location aware device capable of communicating with a central server 104.

The central server 104 stores in its storage 108 an MPM for each user of the system. The central server 104 may represent a single device, but may also, for example, represent a network of devices sharing access to a database or storage 108. The central server 104 is represented in the drawings and the description as a single device for the sake of simplicity, but this representation should not be construed as limiting.

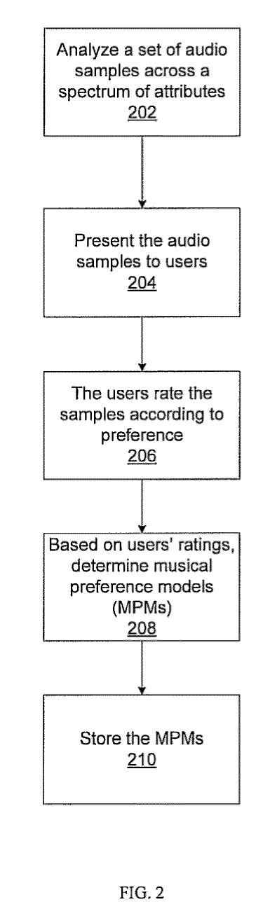

FIG. 2 depicts an exemplary method for creating MPMs. In block 202, a set of audio samples is analyzed across a spectrum of attributes. An exemplary set of attributes include, e.g., “Forcefulness, urban, Smoothness, Earthy, and Sophisticated.” Every piece of music may be described as having a certain degree of each of these attributes. For example, a particular song might have high scores in the “Forcefulness” and “Urban” categories and an especially low score in “Sophisticated,” while another might have high “Smoothness” and be particularly “Earthy.”

Analyzing a set of music samples, in block 204, presents the samples to users which represent a broad range of attributes. The popularity of the song—using samples which the users are already familiar with—poses a risk of tainting their responses with pre-existing emotional associations. In addition, songs which are very popular are less useful for discriminating between users' actual musical preferences. The number of samples to be presented should reflect a balance between the accuracy increase that results from increasing number of songs rated and the proportional increase in the users' irritation as the amount of time which they must invest increases.

In block 206, the users rate the music samples. This rating may represent, for example, a ranking from most preferred to least preferred, or a rating of the individual samples on an absolute scale. Popular songs may be employed or specially designed music sequences or songs may be employed.

In block 208, the users' ratings are then analyzed to create MPMs. These profiles are generated using statistical methods, thereby determining each user's preferred level of each of the attributes. For example, if a user rated many “Earthy” samples highly, with some “Sophisticated” songs also receiving high ratings, and all predominately “Urban” songs receiving low ratings, the user's MPM would have a very high “Earthy” score, a moderately high “Sophisticated” score, and a very low “Urban” score. The attribute scores together represent a most-preferred type of music. Although a variety of statistical techniques exist for producing an MPM, good results can be had simply by averaging the samples, scores, weighted by the user's preferences.

Finally, the system stores, in block 210, the users' MPMs in a storage of the central server or in storage of a user's device (e.g., cell phone or the like). The MNP forms the basis of each user's profile. The profile may also include other information, such as an identifier, an icon, the user's self-description, etc.

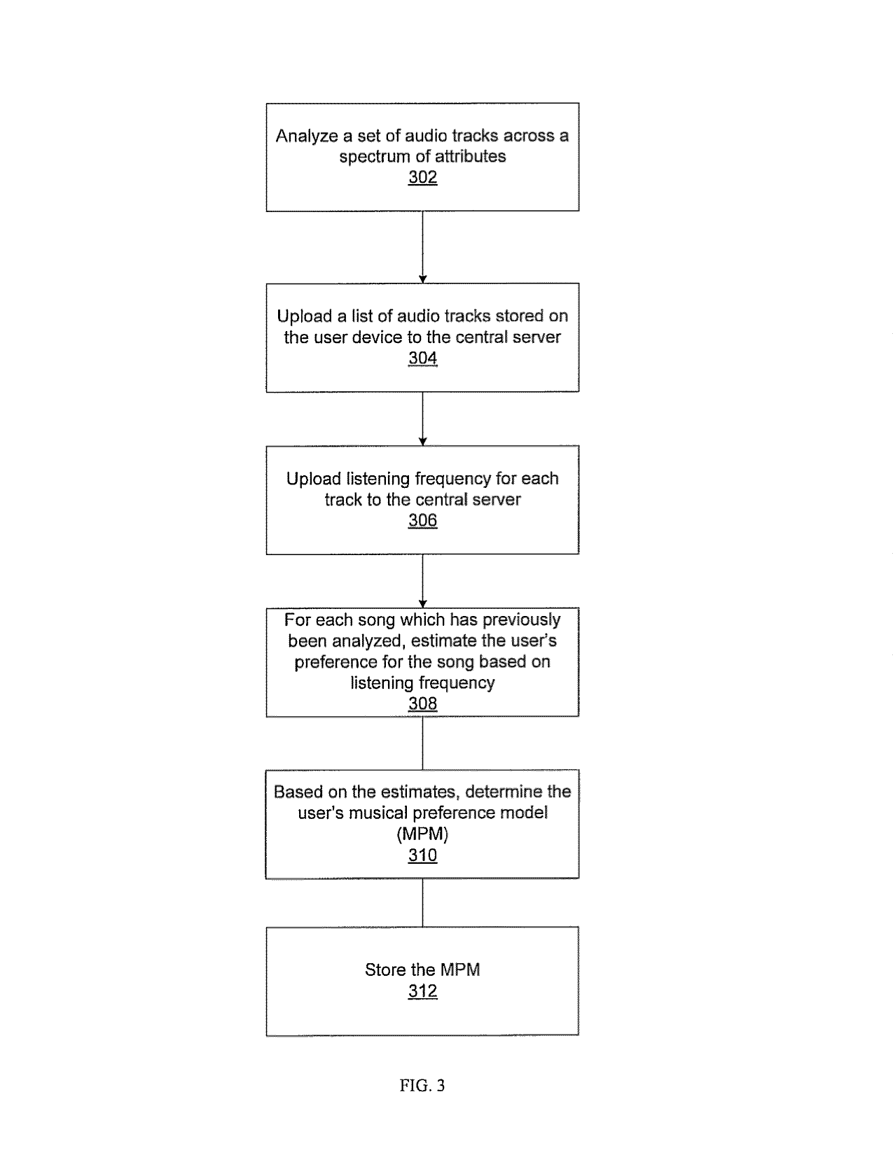

An alternative method for determining a user's MPM is depicted in FIG. 3. This method begins by analyzing, in block 302, a set of full audio tracks. Rather than analyzing relatively small audio samples, as shown in FIG. 2, this method deals with entire songs and will result in a large database of tracks. Particularly popular songs should still be excluded for the reasons described above.

In block 304, a user uploads a list of the audio tracks stored on the user device. This is followed by listening frequency information in block 306 (e.g., how many times per day, week, or year the song is played by the user). This data provides an indirect indication of what music the user prefers to hear. In addition to the basic listening frequencies, additional information may be provided, such as whether a user usually listens through an entire song or skips ahead before the song has finished. Even equalizer settings, volume settings or other data may be employed to further weight preferences.

The track list and the listening frequency information are used, in block 308, to estimate the user's musical preferences. More frequently listened-to tracks are likely to be more highly preferred by the user. One exemplary way for estimating the preferences would be to simply rank the tracks in order of listening frequency and use that ranking as a weighting for each track's attributes.

Using the estimates, in block 310, an MPM for the user is determined. Continuing the example above, the weighted attributes are summed across all of the tracks. For example, the weighted “Forcefulness” values for each track would be summed into one overall “Forcefulness” score. Once overall scores for each attribute are calculated, the scores can be normalized. These normalized attributes represent the user's MPM. The MPH is then stored at the central server in block 312.

Although this alternative method bears the risk of interference from the user's emotional associations with particular songs, discussed above with regard to FIG. 2, it has significant advantages in that it is essentially automatic from the point of view of the user.

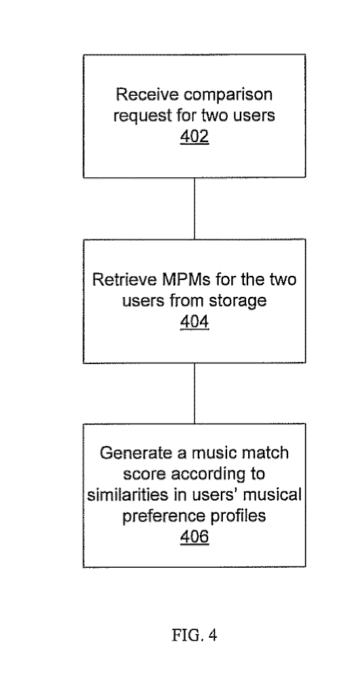

Once the MPMs of a number of users have been stored, there are a wide variety of social networking possibilities based on the comparison of musical preferences. As discussed above, musical preference is an indicator of personality type. As a result, comparison of MPMs, may give an indication of compatibility outside the realm of music. Although the exemplary embodiments described herein focus solely on musical preference matching, those skilled in the art will recognize that musical preference may be combined with a variety of other variables in an SC context to provide additional data regarding user compatibility. An exemplary method for comparison of MPMs is shown in FIG. 4.

Referring to FIG. 4, in block 402, the central server receives a request for a comparison between two users. The central server then retrieves each user's MPM from storage in block 404 and analyzes the similarities between the two HPMs in block 406. One exemplary way for analyzing the similarity would be to represent the MPMs as points in an n-dimensional space (where “n” is the number of attributes in the MPHs) and to determine the Euclidian distance between the points. A smaller distance between points represents a greater similarity between the MPMs. The degree of similarity is represented by a scalar music match score (HMS).

Another technique for finding the similarity would be to find correlations between the MPMs. This can be accomplished simply by treating two MPMs as n-dimensional vectors, and adding the two vectors together. If the users' MPMs are similar, the resulting vector will have a high magnitude in many dimensions. In this way, qualitative comparisons may be made, stating which particular preferences are most similar between two users.

However, it is not sufficient in a social computing context to simply be able to compare users; there should be some way for users to find one another, and some way of judging the relevance of those users to one another. For example, while user A might have extremely similar tastes in music when compared to user B, this information may be of little good when user A lives in Manhattan and user B lives in Belarus. Instead, information about similarities in musical taste with other users may be most useful when it applies to users in the same geographic vicinity.

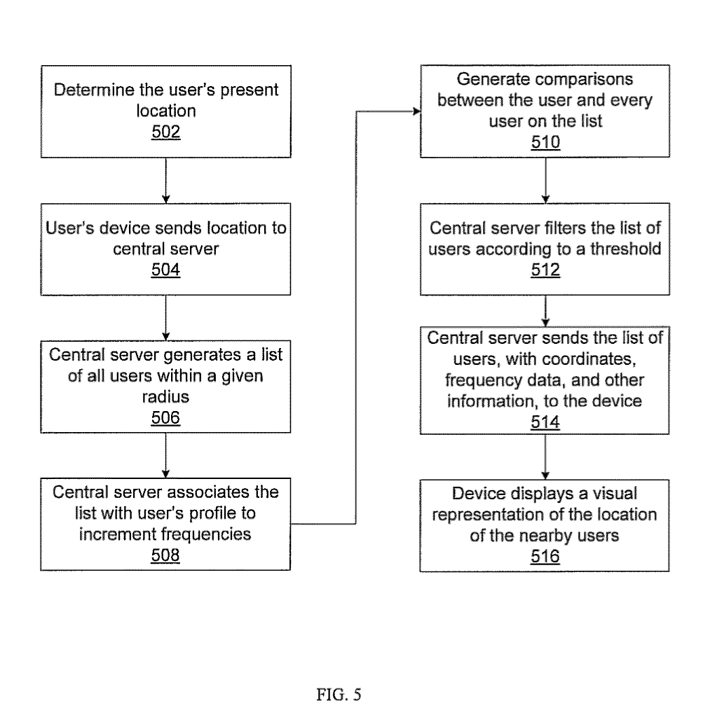

Accordingly, an exemplary method for representing musical preference match data in a useful way is shown in FIG. 5. This method will be described from the perspective of an exemplary user, user A. In block 502, the system first determines the user A's present location, for example by using a UPS receiver in a portable device or by having user A manually enter the location. The user A's device then sends that location information to the central server in block 504. In block 506, the central server generates a list of all users of the system within a certain radius of user A's present location. This radius can be selected by user A, or it can be selected by the central server to reflect the density of users in user A's vicinity.

Using this list, in block 508, the central server changes a set of variables associated with user A's profile, representing the frequency with which the users on the list are in user A's vicinity. For example, if user B rides the train with user A every day at 8 AM, the central server will track and store that information.

In block 510, the central server then generates comparisons between user A and every user on the list. In block 512, the central server filters the list according to a similarity threshold, thereby limiting the list to only those users who are sufficiently similar in musical preferences to user A. This comparison step refers to the comparisons described above with respect to FIG. 4, and may include, for example, calculating a Euclidian distance or other distance, a vector correlation, etc. In block 514, the central server then sends the filtered list of users, along with their coordinates, frequency information, and track information about any music they are currently playing, etc. to user A's device.

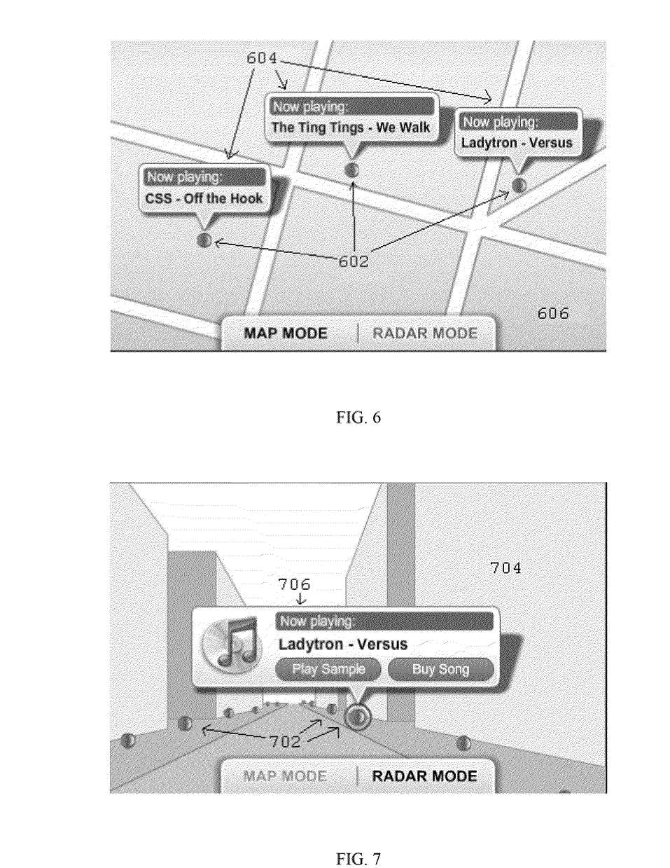

In block 516, the device then displays a visual representation of the list. Exemplary visual representations are depicted in FIGS. 6 and 7. FIG. 6 depicts a “birds-eye view” of the area around user A, showing the locations of other users 602 and what music they are currently playing 604. This representation superimposes the locations of the users on a map of the area 606. FIG. 7 shows a “radar mode” view, which displays nearby users 702 according to how they would appear from user A's perspective 704. The visual representation may include additional information, such as flagging (e.g., by color, icon, text, etc.) users who are frequently in the same vicinity as user A.

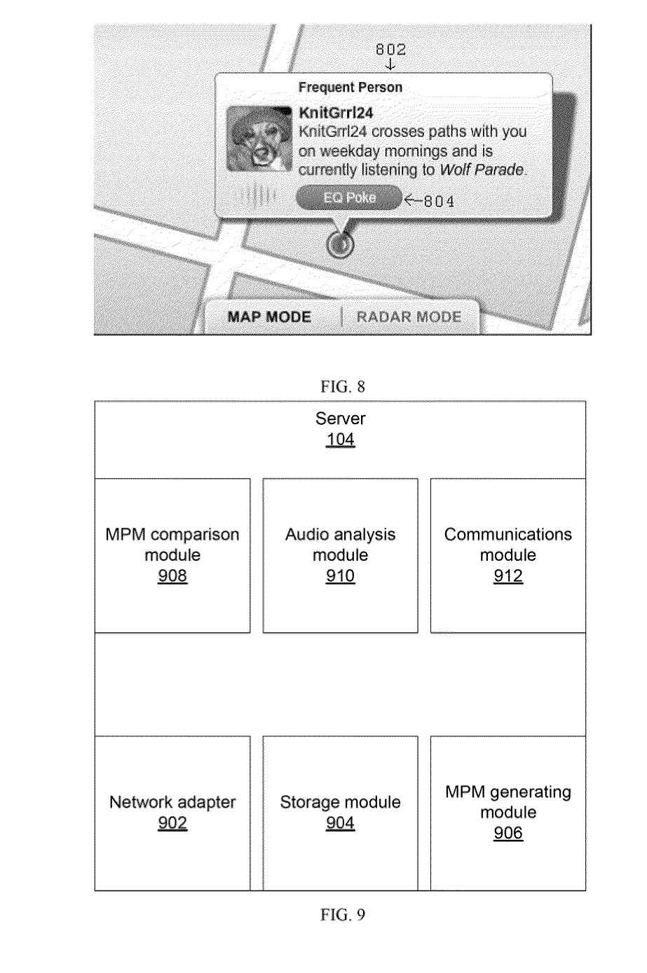

The visual representation may be interactive, allowing user A to request more information about a user (user B). For example, FIG. 8 shows the result 802 of such a request. The central server may provide profile information such as a description of user B, user B's icon, and more detailed frequency information related to why user B is flagged as being a “frequent person.”

The interactive visual representation also allows interaction between the users. This is shown in FIG. 8 in the button labeled “EQ Poke” 804. Such interaction may include a simple “poke” as shown, or may include more elaborate communications such as text messages, instant messages, emails, or voice messages. Users may also have the ability to have the system flag users whom they have designated as friends, as well as the ability to block particular users, such that their presence is not displayed to the blocked users. These features advantageously allow users to discover and meet one another based on musical preferences, while still permitting them to have a measure of privacy and discretion.

A further advantage rests in the display of “currently playing” information 706 as shown in FIG. 7. Because only users who have a sufficiently high MMS are shown, there is a high likelihood that the music played by the displayed users will be of interest. A user may then choose to listen to a sample of the track, or to buy the track outright.

An exemplary configuration for a central server is shown in FIG. 9. The server comprises a network adapter 902 for communicating with users' devices. This network adapter 902 may communicate with devices in any known fashion, including but not limited to connections through the internet, connections through a LAN, direct connections, and wireless communications. The server 104 further comprises a storage module 904 for storing, e.g., users' profiles, MPMs, and location information. The storage module 904 may comprise any sort of writable medium, such as a hard drive or RAM. The server 104 also comprises an MPH generating module 906 for implementing an MPM generating method such as those described above, and an MPM comparison module 908 for implementing an MPM comparison method such as that described above. The server also comprises an audio analysis module 910 for analyzing audio samples or tracks according to a method such as that described above. The server 104 also comprises a communications module 912 for relaying messages between user devices.

The above description is intended to be merely illustrative of the present systems and methods and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. The specification and drawings are accordingly to be regarded in an illustrative manner and are not intended to limit the scope of the appended claims.

What is claimed is:

1. A method for classifying a user's musical preferences, the method comprising:
analyzing a plurality of audio specimens, such that the audio specimens are scored according to a set of representative attributes;
determining a user's degree of preference for the audio specimens;
determining a musical preference model (MPM) for the user based on the user's degree of preference for the audio specimens and the representative attributes of those specimens; and
storing the MPM in a storage module.

2. The method of claim 1, wherein the audio specimens include audio samples.

3. The method of claim 2, wherein the step of determining the user's degree of preference includes playing audio specimens to the user for rating using an audio playback device.

4. The method of claim 3, wherein the user's rating includes a ranking of all of the audio specimens in order of preference.

5. The method of claim 3, wherein the user's rating includes scoring each audio specimen on an absolute scale of enjoyment.

6. The method of claim 3, wherein the step of determining an MPM includes statistically combining the user's ratings for the audio specimens.

7. The method of claim 1, wherein the audio specimens include full audio tracks.

8. The method of claim 7, wherein the step of determining the user's degree of preference includes estimating the user's preference for a given track based upon the frequency with which the user has played the track.

9. The method of claim B, wherein the step of determining an MPM includes statistically combining the user's estimated preferences for the audio specimens.

10. A computer readable medium that includes a computer readable program, wherein the computer readable program when executed on a computer causes the computer to perform the steps of claim 1.

11. A method for social computing comprising:
determining a matching user's current location;
generating a list of users within a given radius of the user's location;
retrieving from a storage module a music preference model (MPM) for each user on the list;
comparing the MPMs of the users on the list to an MPM corresponding to the matching user; and
displaying on a display those users on the list whose MPMs are similar to the matching user's MPH.

12. The method of claim 11, wherein the matching user's location is determined through the use of a global positioning satellite receiver.

13. The method of claim 11, wherein the step of displaying only displays those users whose MPMs match the matching user's MPH within a threshold.

14. The method of claim 11, further comprising the step of maintaining frequency information that shows how frequently particular users have been near the matching user.

15. The method of claim 14, wherein the step of displaying includes displaying users' frequency information.

16. The method of claim 11, wherein the step of displaying includes displaying information about any music which the users are currently playing.

17. The method of claim 11, further comprising the step of enabling communication between the matching user and the displayed users.

18. The method of claim 17, wherein the communication includes any of text messaging, instant messaging, emailing, or voice messaging.

19. The method of claim 11, wherein the step of displaying includes displaying an overhead visual representation of the locations of the users relative to the matching user.

20. The method of claim 11, wherein the step of displaying includes displaying a perspective visual representation of the locations of the users relative to the matching user, as seen from the point of view of the matching user.

21. A computer readable medium that includes a computer readable program, wherein the computer readable program when executed on a computer causes the computer to perform the steps of claim 11.

22. A social computing system, comprising:
a server, including:
a module configured to generate a music preference model (MPM) based on a user's musical preferences;
a storage module for storing MPMs and user profiles;
an MPM comparison module for generating a music match score based on a comparison of at least two MPMs associated with particular users, the users being in communication with the server and having user devices configured to send location information to the server; and
a display configured to provide a visual representation of locations of users having a threshold relationship with other MPMs relative to the location information,

23. The social computing system of claim 22, wherein the server further comprises an audio analysis module for scoring an audio sample according to a set of representative attributes.

24. The social computing system of claim 23, wherein the server is configured to send to the user devices a list of users such that the music match score between the users' MPMs and the MPM of the user device is within a threshold metric.

25. The social computing system of claim 22, wherein the server further comprises a communications module configured to relay messages between user devices.
